(19) United States
(12) Patent Application Publication
(10) Pub. No.: US 2006/0283677 A1
(43) Pub. Date: Dec. 21, 2006

(54) Hydraulic shock absorber

(76) Inventors: Norbert Schmidt, Lorch (DE); Markus Schneider, Herne (DE)

Correspondence Address: JORDAN AND HAMBURG LLP, 122 EAST 42ND STREET, SUITE 4000, NEW YORK, NY, 10168, US

(21) Appl. No.: 11/437,380

(22) Filed: May 19, 2006

(30) Foreign Application Priority Data
May 19, 2005 (DE) 10 2005 022 941.7

(51) Int. Cl. F16F 9/00

(52) U.S. Cl. 188/322.19; 188/322.16

(57) ABSTRACT

Hydraulic shock absorber, at least containing three concentrically arranged cylinder tubes, of which at least the radially exteriorly arranged cylinder tube is provided with an associated passage for receiving at least one module and the module is connected to the exterior cylinder tube via a fastening flange that is provided with a through-hole and that is at least partially supported on the exterior wall of the exterior cylinder tube, whereby provided concentric with the through-hole of the fastening flange is at least one largely cylindrical sleeve that forms a support surface for at least one sealing element that is held sealingly clamped at least between the outer surface area of the sleeve and the inner wall of the through-hole of the fastening flange that is arranged concentric with the surface area.

The invention relates to a hydraulic shock absorber that includes at least three concentrically arranged cylinder tubes.

Known from U.S. Pat. No. 5,353,898 is a vibration damper, the damping behavior of which is variable, comprising a cylinder, a piston attached to a piston rod, a piston rod seal, a number of chambers that are connected to one another depending on the position of the piston, a shut-off valve assembly between the connecting segments of the chambers, whereby the connecting segment is formed from an outer surface area of the cylinder and an inner surface area of the intermediate pipe, at least one radial aperture in the intermediate tube, a tube support surrounding the aperture, a number of tube supports that is the same as the number of shut-off valve assemblies, an intermediate tube length segment, and a guide segment at each end of the intermediate tube length segment. The intermediate pipe has bead-shaped grooves in its guide segments.

EP-A 0 905 408 describes a hydraulic shock absorber including at least one interior cylinder, one exterior cylinder, a piston, a piston rod, an oil channel apparatus, and a tubular part that is arranged between the interior cylinder and the exterior cylinder. A damping apparatus is attached to the exterior cylinder in order to control the flow of the working oil through the oil channel apparatus.

In the prior art, the suggested attachment of the modularly embodied elements on the exterior cylinder is associated with high costs and is very complicated in terms of production engineering. Moreover, the solution suggested in U.S. Pat. No. 5,353,898 involves very complex shaping and production.

In the prior art, some sealing elements are suggested that are embodied as rubber/metal elements. These elements are produced in that a rubber covering is vulcanized onto the metal elements. Such rubber/metal elements are consequently expensive to produce.

The object of the invention is to avoid the aforesaid disadvantages and to provide a hydraulic shock absorber in which a cost-effective and structurally simple solution is provided for attaching an additional module.

This object is attained by a hydraulic shock absorber, at least containing three concentrically arranged cylinder tubes, of which at least the radially exteriorly arranged cylinder tube is provided with an associated passage for receiving at least one module and the module is connected to the exterior cylinder tube via a fastening flange that is provided with a through-hole and that is at least partially supported on the exterior wall of the exterior cylinder tube, whereby provided concentric with the through-hole of the fastening flange is at least one largely cylindrical sleeve that forms a support surface for at least one sealing element that is held sealingly clamped at least between the outer surface area of the sleeve and the inner wall of the through-hole of the fastening flange that is arranged concentric with this surface area.

Advantageous further developments of the inventive subject are found in the subordinate claims.

The inventive subject provides a number of structural embodiments that are distinguished from the prior art such that it is possible to attach an additional module to an exterior cylinder tube of the hydraulic vibration damper, which attachment is simple in terms of production engineering and is thus cost-effective. In addition, all embodiments are very easy to assemble because assembly is simple.

All of the designs for the inventive subject make use of at least one sleeve and at least one sealing element that is preferably embodied as an O-ring. Depending on the design of the inventive subject, a separate spacer disk having a recess can be provided between the exterior and the center cylinder tube, which disk encloses the sleeve with respect to the sealing element.

Alternatively, the center or exterior cylinder tube can be reshaped in the area of the sleeve, forming a corresponding spacer element, specifically in the direction of the other cylinder tube. The spacer element being used contributes to maintaining a pre-specified radial distance between the exterior cylinder tube and the center cylinder tube.

Instead of the separate or integrated spacer elements, there can also be other solutions for maintaining spacing between the two cylinder tubes. For instance, the sealing element can be inserted into corresponding recesses of the center and exterior cylinder tubes. If needed, metallic reinforcing elements or the like can also be inserted here.

One skilled in the art will provide the appropriate solution depending on the application.

The inventive subject is depicted in the drawings using an exemplary embodiment and is described as in the following.

### BRIEF DESCRIPTION OF THE DRAWINGS

FIGS. 1 through 5 depict various designs of the inventive subject in a number of elevations and sections.

FIGS. 1 through 5 depict various views of partial areas of hydraulic shock absorbers 1, whereby FIGS. 1 through 3 have a similar structural design and FIGS. 4 and 5 are structurally different. The labels are identical for identical parts when this makes sense. See the description of the prior art in the foregoing for the structural design of the hydraulic shock absorber 1 that works using the two-chamber principle and that has three concentrically arranged cylinder tubes 2, 3, 4 in which an additional module 5 is fastened to the exterior cylinder tube 2. Only the attaching of the module 5 to the hydraulic shock absorber 1 is depicted and described in the exemplary embodiments in accordance with FIGS. 1 through 5.

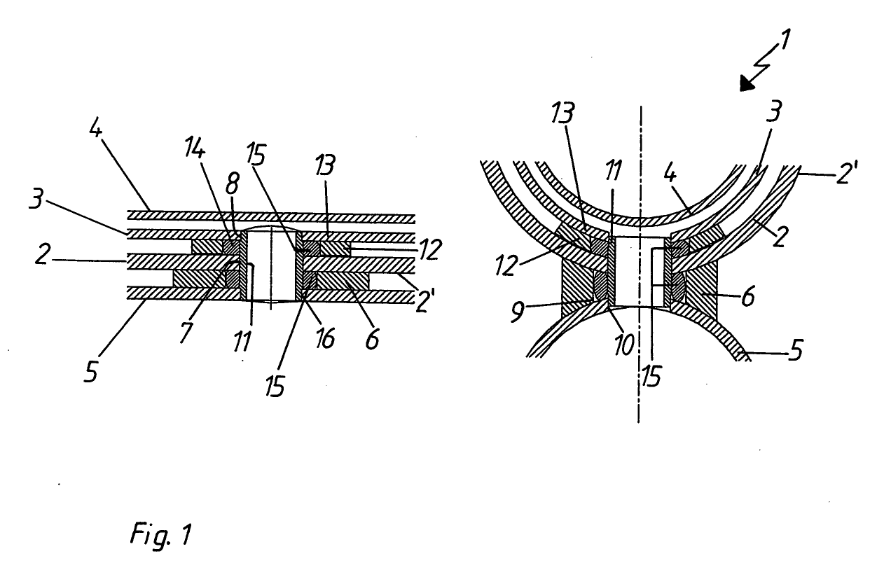

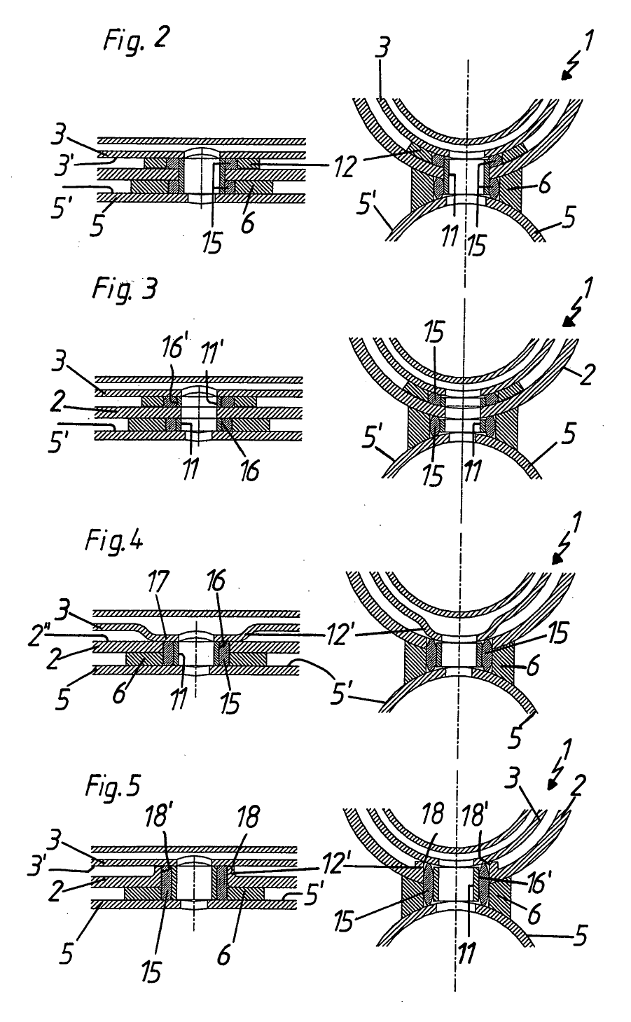

The following first has to do with the embodiments in FIGS. 1 through 3 because they have the most equivalent features. Via a fastening flange 6 that is supported on the outer wall 2′ of the exterior cylinder tube 2, the module 5 is connected thereto. The fastening flange 6 is preferably welded to the exterior cylinder tube 2 and/or to the module 5, for instance using KE welding, which has already been tested in series. Both the exterior cylinder tube 2 and the center cylinder tube 3 are provided with flush passages 7, 8. Similarly, the fastening flange 6 and the module 5 each include a through-hole 9, 10. The passages 7, 8 have the same diameter as the through-holes 9, 10 and receive a sleeve 11 (FIG. 1). A spacer element 12, in this example embodied as a disk-like spacer (like a ring) extends between the exterior cylinder tube 2 and the center cylinder tube 3.

In FIG. 1, the sleeve 11, at its end that faces the center cylinder tube 3, is provided with a radial shoulder 13 that forms a receiving groove for the center cylinder tube 3 of the hydraulic shock absorber 1. In this manner the sleeve 11 is supported via the radial shoulder 13 on the center cylinder tube 3 and fixed. The spacer element 12 is provided with a clearance 14 and encloses the sleeve 11 with radial spacing. The passages 7, 8, the through-holes 9, 10, and the clearance 14 are thus provided concentric with the sleeve 11. Two sealing elements 15 embodied as O-rings are provided in the exemplary embodiment in accordance with FIG. 1. A first outer O-ring 15 is arranged between the fastening flange 6 and the outer surface area 16 of the sleeve 11. When installed, this outer O-ring 15 is sealingly clamped between all four wall segments surrounding this O-ring. A second inner O-ring 15 is arranged between the exterior cylinder tube 2 and the center cylinder tube 3 of the hydraulic shock absorber 1 and the spacer element 12 with respect to the sleeve 11. In this case as well the surface area 16 of the sleeve 11 forms a first support surface for the O-ring 15, while the inner wall of the clearance 14 of the spacer element 12 forms a second support surface for this O-ring 15. When installed, the second O-ring is likewise sealingly disposed at the wall segments of the exterior cylinder tube 2 and the center cylinder tube 3 of the hydraulic shock absorber 1 that correspondingly enclose the O-ring 15.

The embodiment of the invention depicted in FIG. 1 is particularly simple in terms of structural design since in this embodiment no re-shaping of the concentrically arranged cylinder tubes 2, 3, 4 is required. The sealing attachment of the module 5 to the exterior cylinder tube 2 depicted here makes do with just a few parts that are moreover simple in their structural configuration and are thus particularly cost-effective to manufacture.

The embodiment in accordance with FIG. 2 is very similar to that depicted in FIG. 1. In this case, as well, the fastening flange 6 and the spacer element 12 are arranged in the same manner. A sleeve 11 is likewise provided. In contrast to that in FIG. 1, the sleeve 11 is not provided with a radial shoulder, but rather is embodied completely level and is supported on the exterior wall 3′ of the center cylinder tube 3 and on the exterior circumferential surface 5′ of the module 5. The sealing elements 15 embodied as O-rings are arranged as already described in FIG. 1 and are supported on the same components.

In the exemplary embodiment in accordance with FIG. 3, the main difference from FIGS. 1 and 2 is that it is not a single-part sleeve that is used but rather two sleeves 11, 11′ are provided that are arranged one behind the other as seen from the axial direction, whereby the first (outer) sleeve 11 is arranged between the outer circumferential surface 5′ of the module 5 and the exterior cylinder tube 2 of the hydraulic shock absorber 1 and the second sleeve 11′ is arranged between the exterior cylinder tube 2 and the center cylinder tube 3 of the hydraulic shock absorber 1. The surface areas 16 and 16′ of each of the sleeves 11 and 11′ themselves form a support surface for the respective sealing element 15, also embodied as O-rings in this example.

What is advantageously common to all embodiments that are depicted in FIGS. 1 through 3 is that all three concentrically arranged cylinder tubes 2, 3, 4 of the hydraulic shock absorber 1 can remain unshaped so that attaching the module 5 can be simple in terms of production engineering and can thus be undertaken in a cost-effective manner.

The module 5 can be embodied in a manner similar to the prior art or can include active displacement systems, such as damping valves, that are preferably switchable or controllable.

Apart from the separate spacer elements, FIGS. 4 and 5 make use of the same components that are described in FIGS. 1 through 3, so that the same reference symbols are used.

Only one sleeve 11 is provided again in the embodiment depicted in FIG. 4. For forming a spacer element 12′, the sleeve-side area of the center cylinder tube 3 is technically deformed in the direction of the inner wall 2″ of the exterior cylinder tube 2 and is positioned against the inner wall 2″. In this example, the sleeve 11 extends between the outer circumferential surface 5′ of the module 5 and the curved area 17 (bulge) of the center cylinder tube 3, which forms the spacer element 12′. A sealing element 15 embodied as an O-ring extends between the outer surface area 16 of the sleeve 11 and the surrounding components 2, 3, 5, 6 and is situated sealingly under appropriate pre-stress against the associated wall segments of these components 2, 3, 5, 6 and the outer surface area 16 of the sleeve 11. What is advantageous in terms of this embodiment is that, compared to the embodiments in accordance with FIGS. 1 through 3, it is possible to omit a separate spacer element as well as a second O-ring. Even if the production of this bulge 17 means an additional shaping step for the center cylinder tube 3, depending on the application it can be a reasonable alternative to the embodiments already discussed.

In the embodiment in accordance with FIG. 5 it is not the center cylinder tube 3, but rather the exterior cylinder tube 2 of the hydraulic shock absorber 1 that is provided with a projection 18 that is produced by forming and that is oriented radially inward and that in this example forms the spacer element 12′. Analogous to the bulge 17 in accordance with FIG. 4, the projection 18 oriented radially inward in accordance with FIG. 5 renders superfluous a spacer element between the center cylinder tube 3 and the exterior cylinder tube 2 of the hydraulic shock absorber 1. The sleeve 11 extends between the outer surface area 5′ of the module 5 and the outer circumferential surface 3′ of the center cylinder tube 3. The inner wall 18′ of the projection 18 forms at least in part a positioning surface for the individual sealing element 15 embodied as an O-ring. In FIG. 5, the outer surface area 16 of the sleeve 11 also forms the inner positioning surface for the O-ring 15.

Analogous to the embodiment in accordance with FIG. 4, in the embodiment in accordance with FIG. 5 it is an advantage that in addition to the fastening flange 6 for a sealing attachment of the module 5 to the exterior cylinder tube 2 of the hydraulic shock absorber 1 only two additional components are necessary, specifically the sleeve 11 and a single O-ring 15.

In addition to the advantages already cited for the embodiments in accordance with FIG. 1 through 5, it should also be mentioned that all of the embodiments of the invention described have the common advantage that, compared to the prior art, they represent a solution for attaching the module 5 to the exterior cylinder tube 2 of the hydraulic shock absorber 1 that is easy to assemble. The components used in the embodiments can be used and installed without difficulty so that it is easy to assemble the shock absorber.

### LEGEND

1 Hydraulic shock absorber
2 Cylinder tube
2′ Outer wall
2″ Inner wall
3 Cylinder tube
3′ Outer wall
4 Cylinder tube
5 Module
5′ Outer circumferential surface
6 Fastening flange
7 Passage
8 Passage
9 Through-hole
10 Through-hole
11 Sleeve
11′ Sleeve
12 Spacer element
12′ Spacer element
13 Radial shoulder
14 Recess
15 Sealing element
16 Outer surface area
16′ Outer surface area
17 Bulge
18 Projection
18′ Inner wall

1.-11. (canceled)

12. Hydraulic shock absorber comprising
an assembly comprising at least first, second and third concentric cylindrical tubes, the first being the outermost and the third being the innermost of the three tubes and the second being between the first and the third,
a passage through a wall of at least the outermost, first tube,
a module arranged adjacent to the cylindrical tubes assembly,
a fastening flange provided with a throughhole and supported on the wall of the first tube and connecting the module to the tubes assembly,
at least one substantially cylindrical sleeve received in the flange throughhole, concentrically therewith,
at least one sealing element, the at least one sealing element being disposed sealingly between at least an outer surface area of the sleeve and an inner wall of the flange throughhole, the sealing element being concentric with the outer surface area of the sleeve.

13. Hydraulic shock absorber according to claim 12, wherein the passage also passes through a wall of the second tube and the hydraulic shock absorber further comprises
a spacer arranged between an inner wall surface of said wall of the first tube and an outer wall surface of the second tube, the spacer having an opening therethrough of larger diameter than the outer diameter of the sleeve whereby a clearance is defined between the spacer and the sleeve.

14. Hydraulic shock absorber according to claim 13, further comprising
a radial shoulder formed on an end of the sleeve adjacent to the second tube, the shoulder defining a receiving edge area for receiving said wall of the second tube.

15. Hydraulic shock absorber according to claim 13 or 14, wherein
the clearance is concentric with the passage, the flange throughhole and the sleeve.

16. Hydraulic shock absorber according to claim 13 or 14, wherein the at least one sealing element comprises
a first O-ring arranged between the flange and the sleeve, and
a second O-ring arranged between the first tube and the second tube in the spacer clearance.

17. Hydraulic shock absorber according to claim 12, 13 or 14, wherein
a first end of the sleeve abuts against an outer wall surface of the second tube and a second end of the sleeve abuts against an outer circumferential surface of the module.

18. Hydraulic shock absorber according to claim 13 or 14, wherein
the sleeve comprises first and second sleeve sections;
the first sleeve section being dispose between an inner wall surface of the first tube and an outer wall surface of the second tube; and
the second sleeve section being disposed between an outer wall surface of the first tube and an outer circumferential surface of the module.

19. Hydraulic shock absorber according to claim 18, wherein the at least one sealing element comprises
a first O-ring arranged between the flange and the first sleeve section, and
a second O-ring arranged between the first tube and the second tube in the spacer clearance.

20. Hydraulic shock absorber according to claim 12, wherein the passage also passes through a wall of the second tube and the hydraulic shock absorber further comprises a spacer element disposed adjacent to said passage, said spacer being one of:
a bulge formed by a portion of said second tube extending in the direction of said first tube; and
a projection formed by a portion of said first tube extending in the direction of said second tube.

21. Hydraulic shock absorber according to claim 13, 14 or 20, wherein said sealing element extends substantially across an axial length of said sleeve.

22. Hydraulic shock absorber according to claim 20, wherein said sealing element extends between the sleeve, the first tube, the spacer, the fastening flange, and the outer circumferential surface of said module.
